(19) United States
(12) Patent Application Publication
(10) Pub. No.: US 2023/0415889 A1
(43) Pub. Date: Dec. 28, 2023

(54) DEVICE FOR PROTECTING A HELICOPTER PROVIDED WITH AN ONBOARD HOIST, HOIST PROVIDED WITH SUCH A DEVICE AND HELICOPTER PROVIDED WITH SUCH AN ON-BOARD HOIST

(71) Applicant: Reel, Saint Cyr Au Mont D'or (FR)

(72) Inventors: David Figoureux, Salon De Provence (FR); Adrien Cauquelin, Lyon (FR); Sébastien Decreusefond, Pelissanne (FR)

(21) Appl. No.: 18/135,965

(22) Filed: Apr. 18, 2023

(30) Foreign Application Priority Data
Jun. 23, 2022 (FR) 2206224

(51) Int. Cl. B64D 1/22; B64D 45/00; B64C 27/04

(52) U.S. Cl. CPC B64D 1/22; B64D 45/00; B64C 27/04

(57) ABSTRACT

This device for protecting a helicopter embarking a hoist provided with a hoisting cable against the consequences of an abrupt rupture of said cable, the hoist being provided with an outlet port for the cable, is formed by a shield positioned in the vicinity of the outlet port of the cable or deployable in the vicinity of the outlet port of the cable, said shield being oriented substantially perpendicularly with respect to the direction of said outlet port and extending over a distance of at least 20 centimeters with respect to said outlet port.

### TECHNICAL FIELD

The invention relates to the field of hoisting devices, more particularly on-board aircrafts, particularly helicopters. In addition to the aspects of rescuing of individuals due to helicopters provided with a hoist, the invention also aims at the transporting of people or loads, still by means of helicopters, particularly in premises with a difficult access by other means (wind turbines, ships approaching ports, . . . ).

### BACKGROUND

The implementation of hoists on-board aircrafts, and more particularly helicopters, is currently widespread. Typically, a hoist is mounted within the helicopter and the cable of said hoist is unwound according to needs.

While such on-board hoists, particularly within helicopters, have widely proven their efficiency, there however exist situations where their use may turn out being dangerous, particularly for the helicopter and accordingly for its passengers.

According to regulations, the hoist has to be provided with means capable of severing said cable at the level of the hoist or of the cabin when, in the presence of critical conditions, such as a motor failure of the helicopter during a hoisting operation, for example, the crew needs, for the helicopter security, severing said cable.

There often occurs that during a hoisting, the cable gets caught in an obstacle (pylon, tree, etc . . . ) requiring the actuation by the crew of said severing means.

However, in certain cases of jamming, in case of an abrupt over-tension associated with a local damaging of the cable, for example due to a sharp edge, for example, the cable may break before the crew could react. In this case, the cable is severed at a non-negligible distance from the helicopter.

In such occurrences, due to the tension exerted on the cable by the load that it carries or by the helicopter, an elastic effect tending to have the severed end of the cable and the cable itself abruptly rise towards the helicopter can be observed. Thereby, the cable is likely to reach the helicopter blades and may thus generate effects likely to cause the fall of the helicopter, with the dramatic consequences resulting therefrom in terms of security of the helicopter passengers, in addition, should the case arise, to the place where the helicopter falls.

To overcome this redhibitory disadvantage, it is possible to use cables oversized with respect to the load that they are intended to hoist, to increase their weight and, accordingly, limit the cable rise under the elastic effect inherent to the tension to which they are submitted. Thereby, the risk of seeing the end of the cable rise above the level of the hoist is avoided. However, the implementation of such heavier cables generates the need for a more powerful and also heavier hoist, which is precisely what such hoists attempt to avoid.

The object of the invention is to overcome these different disadvantages by providing a device simpler to implement and complying with security requirements.

### SUMMARY OF THE DISCLOSURE

For this purpose, the invention aims at a device for protecting a helicopter provided with an on-board hoist against the consequences of an abrupt rupture of the cable of said hoist, whether said rupture is fortuitous or intentional, said hoist being provided with a cable outlet port.

According to the invention, this device comprises a permanent shield attached in the vicinity of the cable outlet port or deployable in the vicinity of the cable outlet port. This shield is advantageously oriented substantially perpendicularly to the direction of said outlet port; it is intended to extend the surface area of protection of the helicopter resulting from the actual hoist, and particularly of the protection cowl fitting said hoist, by a distance at least equal to 20 centimeters measured from said outlet port.

In other words, the invention comprises providing the hoist with a shield or cowl, capable of receiving the cable strand under the assumption of an elastic return thereof as a result of an abrupt rupture, and capable of opposing the rising of said cable strand above said hoist and particularly beyond the protective cowling of the hoist, and thus to prevent it from winding on and, generally, interfering with the helicopter blades.

Experience proves that with a shield or cowl typically extending with a minimum 20 centimeters, and advantageously between 20 and 50 centimeters, beyond the cable outlet port of the hoist, any risk of rise of the cable strand above the hoist, and thus towards the blades, is avoided, thus providing security to the helicopter provided with the hoist in question.

According to a first embodiment, this shield is rigid and permanently fixed in the vicinity of the cable outlet port. This shield may also be formed of a metal sheet having a stiffness sufficient to absorb the shock inherent to the abrupt rise of the end of the cable in case of a rupture. It may also be made of a plate of composite material, or even of plastic material, also rigid.

According to an embodiment, the shield is formed of a net or open-worked grid, rigidly attached in the vicinity of the outlet port of the hoist by means of a rigid rod or the like. Thereby, the helicopter lift is less significantly altered due to the open-worked nature of the net or of the grid.

According to still another embodiment, the shield is deployable in the vicinity of said port for letting out the cable outside of the hoist, like an airbag.

The invention also concerns a helicopter provided with an on-board hoist, wherein the hoist is mounted on a rotating arm to allow the operation of the hoist in use, the hoist in question being provided with the previously-mentioned device.

### BRIEF DESCRIPTION OF THE DRAWINGS

The way in which the invention may be implemented and the resulting advantages will better appear from the following non-limiting embodiments, in relation with the accompanying drawings.

FIG. 1 is a simplified view of a helicopter provided with a hoist.

FIG. 2 schematically illustrates a hoist provided with its cowling.

FIG. 3 illustrates the threshold of FIG. 2 provided with the device according to a first embodiment of the invention.

FIG. 4 is a side view of the hoist of FIG. 3.

FIG. 5 illustrates the hoist of FIG. 2 provided with the device according to a second embodiment of the invention.

FIG. 6 is a side view of the hoist of FIG. 5.

FIG. 7 illustrates the hoist of FIG. 2 provided with the device according to a third embodiment of the invention.

### DETAILED DESCRIPTION

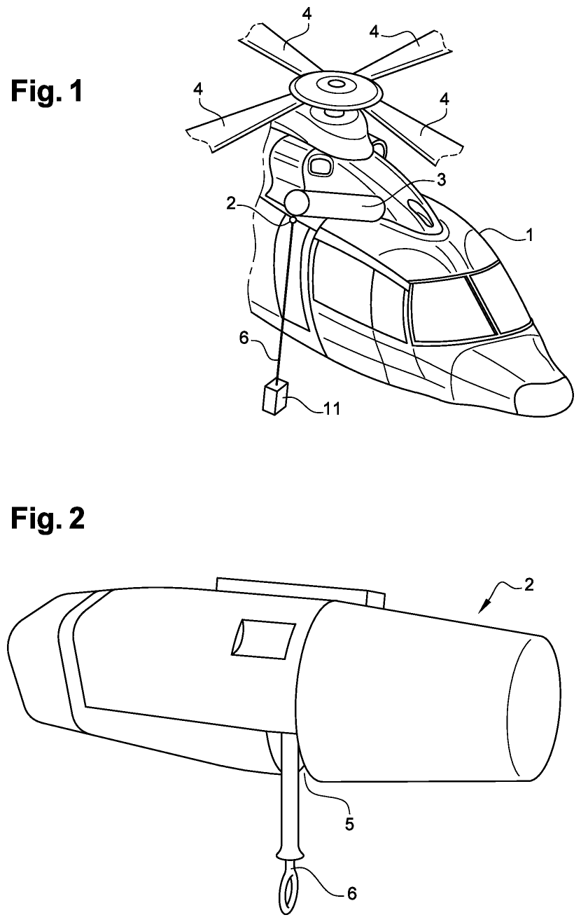

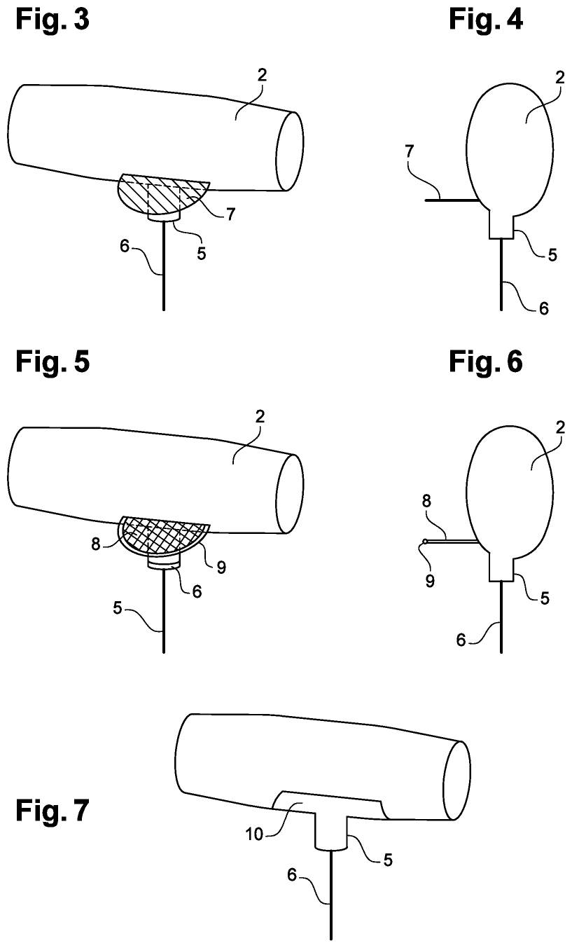

There has been illustrated, in relation with FIG. 1, a helicopter (1) provided with its blades (4). This helicopter comprises a hoist (2) assembled on a removable arm (3). The arm is intended to enable the hoist to come out of the helicopter cabin, to allow its operation in operating mode. Such an arm, which may also be fixed, is known per se, so that it is not necessary to describe it any further.

According to the invention, the hoist is typically formed of a storage and/or hoisting drum, or even of a capstan associated with a storage drum. It is actuated by means of one or a plurality of electric motors, according to whether said hoist limitingly comprises a storage and hoisting drum or a storage drum and a capstan, the pulling force then being provided by the actual capstan. The advantages of such a capstan hoist are also widely known, so that it is not necessary to describe it in detail herein.

Whether said hoist comprises a simple storage drum and/or a storage and hoisting drum, it comprises an outlet port (5) for the cable (6), at the end of which a load or an individual (11) is meant to be hoisted.

According to a feature of the invention, there is positioned in the vicinity of this outlet port (5) of the cable (6), and more particularly slightly above this port, and according to a first embodiment of the invention, a metal sheet (7), fastened by any means to said hoist, the latter being provided with capabilities, of tapered hole type, adapted to allowing the fastening by screwing of the metal sheet.

In the case in point, this metal sheet (7) extends substantially perpendicularly to the main direction of the outlet port (5) of the hoist (6), along a distance at least equal to 20 centimeters, and advantageously in the range from 20 to 50 centimeters with respect to said cable outlet port. In the described example, this metal sheet (7) extends substantially perpendicularly to the main direction of the outlet port (5) of the hoist (6), along a distance at least equal to 20 centimeters, and advantageously in the range from 20 to 50 centimeters with respect to said cable outlet port.

This metal sheet is relatively stiff to enable to stop the cable in case of an abrupt rupture thereof and of its rise by elastic effect towards the helicopter, and to resist vibrations while providing a minimum resistance to air in the helicopter travel direction or in the vertical direction to minimize the loss of lift generated by the rotor (blades 4).

As can be observed in the drawings, this metal sheet (7) is attached at the periphery of, or even slightly above, the outlet port (5) to avoid hindering the upward and downward displacement of the cable through said port (5).

This metal sheet (7) may be replaced with a plate of rigid plastic material.

Alternatively, and as illustrated in FIGS. 5 and 6, this metal sheet (7) may be replaced with an open-worked surface (8), typically formed of a net or of a metal grid, maintained in the plane where this protection device extends by a beam or a rigid rod (9) coming out of the hoist. This embodiment has the advantage of decreasing the alteration of the lift resulting from said device.

According to still another embodiment of the invention, this protection device is only deployed when an abrupt rupture of the cable (6) is detected. This detection may, for example, be measured by the instantaneous determination of the value of the torque which exerts on the hoisting drum or the capstan forming part of the hoist.

According to this embodiment, the protection device is, in normal operating mode, collapsed inside of the hoist in a housing provided for this purpose, and protected by a cowl (10) of appropriate dimensions, and deploys extremely rapidly by means of pyrotechnic means for example, in the same way as an airbag, as soon as an abrupt rupture of the cable (6) is detected.

In this configuration, an inflatable bead deploys, in a plane similar to that containing the metal sheet (7) of the first described embodiment, a net concurrently stretching within the surface area then defined by said bead.

By the implementation of such a protection device, the Applicant could observe that, whatever the tension exerted on the cable at the time of its abrupt rupture, likely to generate an abrupt rise thereof, said cable hits the lower surface of the device, without continuing beyond the plane containing the latter, and thus with no risk of seeing the cable thus broken getting caught in the helicopter blades.

The full advantage of the present invention which, by means of a device which is simple to implement, enables to overcome any risk of entanglement of the cable in the helicopter blades and thereby, to optimize the security thereof and of its occupiers, can thus be measured.

1. A device for protecting a helicopter provided with an on-board hoist provided with a hoisting cable against the consequences of an abrupt rupture of said cable, the hoist being provided with an outlet port for the cable, wherein said device is formed by a shield positioned in the vicinity of the outlet port of the cable or deployable in the vicinity of the outlet port of the cable, said shield being oriented substantially perpendicularly with respect to the direction of said outlet port and extending over a distance of at least 20 centimeters with respect to said outlet port.

2. The device for protecting a helicopter according to claim 1, wherein the shield extends over a distance in the range from 20 to 50 centimeters with respect to the port for letting out the cable outside of the hoist.

3. The device for protecting a helicopter according to claim 1, wherein the shield is formed of a metal sheet having a stiffness sufficient to absorb the shock inherent to the abrupt rise of the end of the cable in case of a rupture.

4. The device for protecting a helicopter according to claim 1, wherein the shield is formed of a plate made of rigid plastic material.

5. The device for protecting a helicopter according to claim 1, wherein the shield is formed of a net or open-worked grid, rigidly attached in the vicinity of the outlet port of the hoist by means of a rigid rod or the like.

6. The device for protecting a helicopter according to claim 1, wherein the shield is formed of an inflatable bead associated with a net, the assembly thus defined being received in a dedicated housing within the hoist, and being only deployed under the action of pyrotechnic means when an abrupt rupture of the cable is detected, the inflatable bead then defining a surface oriented substantially perpendicularly with respect to the direction of said outlet port and within which a net is stretched concurrently to the deployment of said bead.

7. A hoist provided with a hoisting drum or with a capstan on which is wound a cable at the end of which is fastened a load, and integrating a motor capable of ensuring the rotation of the hoisting drum or of the capstan, provided with a protection device according to claim 1.

8. The hoist according to claim 7, comprising a detector of the abrupt rupture of the cable.

9. The hoist according to claim 8, wherein the detector of the abrupt rupture of the cable is formed by a sensor of the torque exerted by the cable on the hoisting drum or on the capstan.

10. A helicopter provided with a hoist according to claim 7.
